(19) United States
(12) Patent Application Publication
(10) Pub. No.: US 2020/0037828 A1
(43) Pub. Date: Feb. 6, 2020

(54) Cleaning Pad and Method for Making the Same

(71) Applicant: Robert Wise, Penngrove, CA (US)

(72) Inventor: Robert Wise, Penngrove, CA (US)

(21) Appl. No.: 16/598,421

(22) Filed: Oct. 10, 2019

Related U.S. Application Data
(63) Continuation-in-part of application No. 16/439,118, filed on Jun. 12, 2019.
Application No. 16/439,118 is a continuation-in-part of application No. 16/049,125, filed on Jul. 30, 2018.
Application No. 16/049,125 is a continuation-in-part of application No. 15/674,311, filed on Aug. 10, 2017.
Application No. 15/674,311 is a continuation-in-part of application No. 15/640,772, filed on Jul. 3, 2017, now Pat. No. 10,059,549.
Application No. 16/439,118 is a continuation-in-part of application No. 15/483,021, filed on Apr. 10, 2017, now abandoned.
(60) Provisional application No. 62/515,152, filed on Jun. 5, 2017.

(51) Int. Cl. A47K 10/16; B32B 27/30; B32B 27/10

(52) U.S. Cl. CPC A47K 10/16; B32B 2555/02; B32B 27/10; B32B 27/306

(57) ABSTRACT

A cleaning pad with a reinforcement layer and a method for making the same. The cleaning pad has a first layer of material with a reinforcement layer applied to a first side of the first layer. A second layer of the first material is then applied over the reinforcement layer. An imprinting device then pressed into the top side of the cleaning pad to give the pad a textured surface. In addition, more layers of material can be added to the cleaning pad. By adding another layer of adhesive to the cleaning pad then applying more layers of material the cleaning pad can be made of any thickness desired. By adding a second adhesive to a select number of sheets of the cleaning pad a core is created. Any number of cleaning pad sheets can then be rolled onto the core to create a roll of cleaning pads.

### CROSS REFERENCE TO RELATED APPLICATIONS

This application is a continuation-in-part of applications and claims the benefit of U.S. application Ser. No. 16/439,118 filed on Jun. 12, 2019, which claims the benefit of U.S. application Ser. No. 16/049,125 filed on Jul. 30, 2018 which claims the benefit of U.S. application Ser. No. 15/640,772 filed on Jul. 3, 2017 which claims the benefit of U.S. Provisional Patent Application No. 62/515,152 filed on Jun. 5, 2017, U.S. application Ser. No. 15/674,311 filed on Aug. 10, 2017, and U.S. application Ser. No. 15/483,021 filed on Apr. 10, 2017. The above identified patent applications are herein incorporated by reference in their entirety to provide continuity of disclosure.

### BACKGROUND OF THE INVENTION

The present invention relates to cleaning pads. More specifically, the present invention provides a cleaning pad having a reinforcement layer, in a roll or as individual sheet pads.

Devices have been disclosed in the known art that relate to toilet paper and cleaning towels. These include devices that have been patented and published in patent application publications. These devices in the known art have several known drawbacks. For example, these singular toilet paper and cleaning towels fail to adequately remove waste from a given surface, thereby requiring the use of numerous towels or squares to achieve a satisfactory cleaning.

Many people rely on paper rolls of various types or styles to clean themselves after using the bathroom. Large quantities of paper rolls are being consumed on a daily basis across the world. As traditional paper rolls are rolled around a rigid cardboard core, this leads to excessive amounts of waste generated, as the rigid cores are thrown away and crowd landfills. Additionally, environmental concerns, costs of manufacturing and shipping these cardboard cores increase the overall costs of manufacturing a paper roll. Cardboard cores require can increase cost astronomically, as they are a large percentage cost of each roll.

Previous attempts to cost and environmental concerns of a paper roll having a core have had limited to no success, however some problems are left unaddressed. One product uses a rigid cardboard tube as a core that is made of a biodegradable material to minimize waste generation. However, leaves a costly additional step in the manufacturing process of creating and transporting the cardboard tube materials. Another product eschews the cardboard tube in favor of simply winding paper to create a coreless paper roll, however these paper rolls collapse under the weight of the paper, leading to difficulty in unrolling the paper for use. Therefore, a paper roll that eliminates environmental waste and minimizes manufacturing costs, while still providing a convenient to use paper roll is needed.

In light of the devices disclosed in the known art, it is submitted that the present invention substantially diverges in design elements from the devices in the known art and consequently it is clear that there is a need in the art for an improvement to existing cleaning pad devices. In this regard, the instant invention substantially fulfills these needs. Consequently, there is a need in for an improvement in the art of paper cleaning products. The present invention substantially diverges in design elements from the known art while at the same time solves a problem many people face when using and disposing of paper cleaning products. In this regard the present invention substantially fulfills these needs.

### SUMMARY OF THE INVENTION

In view of the foregoing disadvantages inherent in the known types of toilet paper and cleaning towels now present in the art, the present invention provides a new cleaning pad having a reinforcement layer wherein the same can be utilized for providing convenience for the user when cleaning and scrubbing debris from surfaces. The cleaning pad includes a front panel that is coextensive and attached with a base panel, wherein a reinforcing layer is positioned therebetween, on the front panel, and/or on the base panel. The reinforcing layer provides a foundation to the cleaning pad, and textured elements on the front panel are configured for scrubbing for the removal of debris from surfaces and absorbency pockets between the back layer. In one embodiment the cleaning pad is a single layer of tissue that has the membrane on the backside is then coated in adhesive this allows the cleaning pad to be a single ply.

The present system comprises a plurality of sheets spirally wound about an axis to form a roll. The roll comprises a first end and a second end, wherein the first end forms an inner section. The inner section defines an axial passageway extending from a first side of the roll to a second side of the roll. The plurality of sheets of the first end, making up the inner section, are bonded together by an adhesive, wherein the adhesive is configured to stiffen the inner section. The roll of sheets forms the stiffened 1^{st} end, the 2^{nd} end of the roll is continually rolled, less adhesive so as to be used individually, using the same paper to create the roll and go on to roll the paper around the core creating a usable roll. In some embodiments, the adhesive is configured to degrade when in contact with water. In another embodiment, the adhesive is configured to stiffen the predetermined inner section more ridged than for the second end to be rolled onto using the same paper source and winding machine. In other embodiments, the adjacent sheets of the plurality of sheets are divided by perforations. In yet another embodiment, the inner section comprises 4-6 layers of the plurality of sheets. In some embodiments, the axial passageway comprises a substantially circular cross-sectional shape. In another embodiment, the adhesive further comprises a fragrance agent. In other embodiments, the fragrance agent is configured to emit a scent when exposed to air. In yet another embodiment, the fragrance agent is configured to emit a scent when in contact with water. In some embodiments, the adhesive further comprises a non-chemical disinfectant configured to sanitize a container having a volume of water therein, such as a toilet bowl. In another embodiment, the adhesive comprises polyvinyl alcohol. In other embodiments, the plurality of sheets further comprises textured elements thereon. In yet another embodiment, the inner section further comprises corrugation configured to provide rigidity and a roll stop when installed in on a horizontal paper dispenser. In one embodiment the cleaning pads are single sheets in a stack.

The present method comprises winding a plurality of sheets about a low-friction tube to form a roll, applying adhesive to the plurality of sheets at a first end of the roll to form an inner section having an axial passageway, curing the adhesive to provide rigidity to the inner section, and removing the low-friction tube from the roll. In some embodiments, the low-friction tube comprises a tubular platen having a plurality of recesses disposed about an outer surface thereof, wherein each of the plurality of recesses comprises an aperture therein. In other embodiments, the method further comprises circulating air through the tubular platen such that negative pressure is generated at the apertures, thereby securing the plurality of sheets to the tubular platen. In another embodiment, the temperature of the air circulated through the or around tubular platen is configured to decrease curing time of the applied adhesive. In other embodiments, the method further comprises generating positive pressure at the plurality of recesses to remove the roll from the tubular platen. In one embodiment the tubular platen has a draft towards one end. This will allow the log of paper roll to easily be slid off of the platen. In yet another embodiment, the method further comprises cutting the log roll to a desired length. In some embodiments, the method further comprises packaging the roll for distribution. In another embodiment, the adhesive further comprises a fragrance agent. In other embodiments, the adhesive further comprises a non-chemical disinfectant. In yet another embodiment, the method further comprises determining the desired thickness of the roll. In some embodiments, the method further comprises applying adhesive to additional layers of the first end to increase the rigidity of the inner section. This will create a more resilient core. This means that when the core is crushed it will spring back to its original shape.

It is therefore an object of the present invention to provide a new and improved single varied layered cleaning pad that is more efficient and effective at cleaning surfaces.

It is another object of the present invention to provide a dissolvable cleaning pad that may be discarded in water or other solutions with no detrimental effects of blockage and the like, reducing dramatically the volume of cleaning pads flushed daily.

Another object of the present invention is to provide a cleaning pad that may be readily fabricated from materials that permit relative economy and are commensurate with durability.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an overhead view of the cleaning pad.

FIG. 2 shows an overhead view of the cleaning pad in an alternative embodiment.

FIG. 3 shows an exploded view of one embodiment of the cleaning pad.

FIG. 4 shows a plurality of cleaning pads joined end to end.

FIG. 5 shows a plurality of cleaning pads mounted to a solution dispensing device.

FIG. 6 shows a perspective view of an embodiment of the paper roll.

FIG. 7 shows a side view of an embodiment of the paper roll.

FIG. 8 shows a side view of an embodiment of the paper roll in a dispenser.

FIG. 9 shows a flow diagram of an embodiment of the method of manufacturing a paper roll.

FIG. 10 shows a perspective view of an embodiment of a cleaning pad using an adhesive.

FIG. 11 shows a cross-sectional view of an embodiment of the cleaning pad having two tissue layers.

FIG. 12 shows a cross-sectional view of an embodiment of the cleaning pad having three tissue layers.

FIG. 13 shows a perspective view of an embodiment of the cleaning pad connected together with perforations.

FIG. 14 shows a perspective view of an embodiment of the cleaning pad with finger slots.

FIG. 15 shows a flow chart for an embodiment of a method for making a cleaning pad.

FIG. 16 shows a flow chart for an embodiment of a method form making rolls of the cleaning pad.

FIG. 17 shows a perspective view of an embodiment of a cleaning pad having a texturing device pushing into the cleaning pad.

FIG. 18 shows a cross-sectional view of an embodiment of a cleaning pad with texture placed therein.

FIG. 19 shows a cross-sectional view of an embodiment of a cleaning pad with a texture placed therein and a second layer of material.

FIG. 20 shows a perspective view of an embodiment of the textured cleaning pad.

### DETAILED DESCRIPTION OF THE INVENTION

Reference is made herein to the attached drawings. Like reference numerals are used throughout the drawings to depict like or similar elements of the cleaning pad. For the purposes of presenting a brief and clear description of the present invention, the preferred embodiment will be discussed as used for cleaning a body part of a user. The figures are intended for representative purposes only and should not be considered to be limiting in any respect.

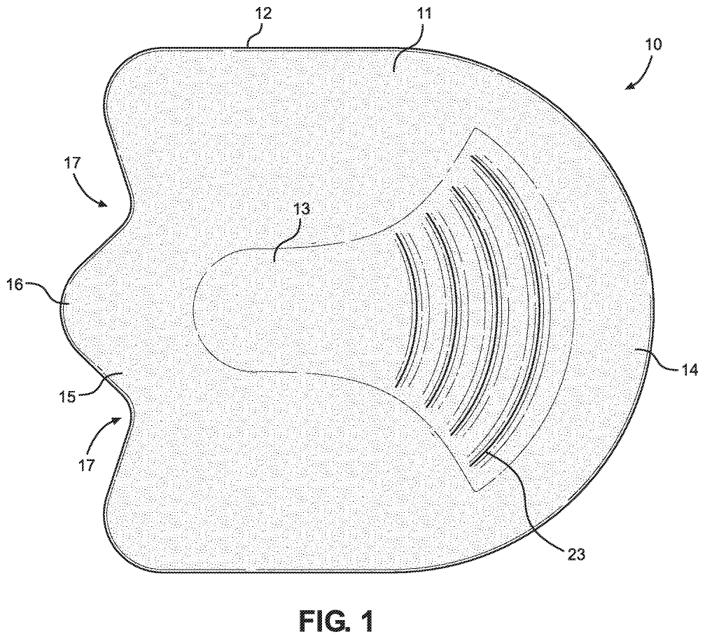

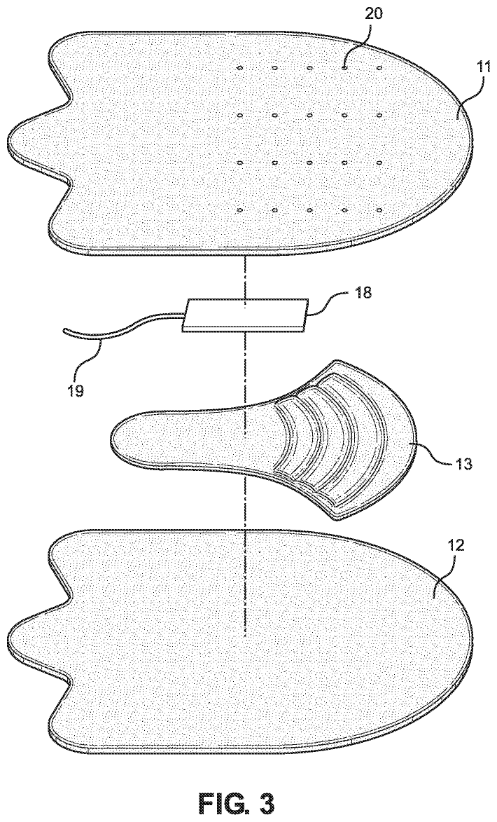

Referring to FIG. 1, there is shown an overhead view of the cleaning pad. The cleaning pad 10 provides a layered sheet having a textured element configured to frictionally engage a desired surface to clean or otherwise remove debris therefrom. The cleaning pad 10 comprises a front panel 11 joined to a base panel (shown in FIG. 3, 12), wherein a reinforcing layer 13 is disposed therebetween. In an alternative embodiment, the reinforcing layer 13 may be disposed on the front panel 11 and/or the base panel. The cleaning pad 10 further includes a first end 14 and a second end 15, wherein the second end 15 includes a protruding tab 16 and a pair of recesses 17 adjacent the tab 16. The protruding tab 16 and a pair of recesses 17 provide a gripping surface for handling the cleaning pad 10.

In the shown embodiment, the front panel 11 is coextensive and attached with the base panel. The front panel 11 and base panel may be formed from a single ply or multiple plies of paper. In one embodiment, the front panel 11 is made from paper material in a single ply configuration. The front panel 11 includes textured elements 23 that are configured for scrubbing debris from surfaces. The textured elements 23 may include alternating or consecutive series of ridges and recessed channels. In the shown embodiment, the textured elements 23 are ridges that are positioned towards a center region of the cleaning pad 10. In this way, as the cleaning pad 10 is manipulated across a surface, the textured elements 23 and the front panel 11 frictionally engage with debris to remove the debris therefrom. In an alternative embodiment, the textured elements 23 are disposed on the reinforcing layer 13.

In one embodiment, the front panel 11 and the base panel are removably joined along a perimeter of the cleaning pad 10. In another embodiment, a fragrance agent is impregnated within the front panel 11, the reinforcing layer 13, and/or the base panel. The fragrance includes, without limitation, fragrances of perfume, clove, flowers, peppermint, spearmint, fruit flavor, apple, lemon, cinnamon, grape, vanilla, and chocolate.

In the shown embodiment, the reinforcing layer 13 is positioned between the base panel and the front panel 11. The reinforcing layer 13 provides structural rigidity so as to allow the general shape of the cleaning pad 10 to be retained upon scrubbing or other frictional engage with a surface. In the shown embodiment, the reinforcing layer 13 is a planar conical member that is tapered from the first end 14 to the second end 15.

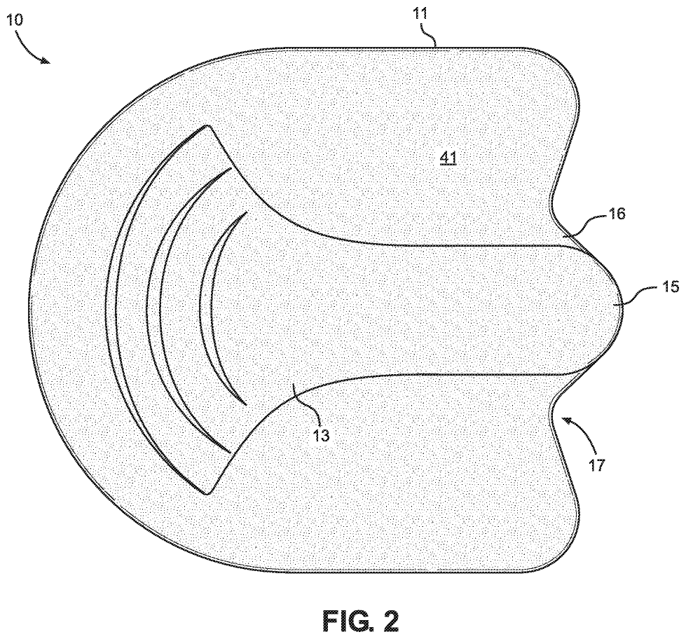

Referring to FIG. 2, there is shown an alternative embodiment of the cleaning pad. In the shown embodiment, the reinforcing layer 13 is disposed on the exterior surface 41 of the front panel 11. Additionally, the reinforcing layer 13 extends over the protruding tab 16 of the cleaning pad 10, and terminates flush with the edge of the second end 15. In this way, the cleaning pad 10 is adapted to be pulled from a dispenser via the protruding tab 16. In alternative embodiments, the reinforcing layer 13 extends partially or fully over a width of the cleaning pad 10, the width being between the first end and the second end 15.

Referring to FIG. 3, there is shown an exploded view of one embodiment of the cleaning pad. In the shown embodiment, the cleaning pad includes a solution package 18 disposed between the front panel 11 and the base panel 12. The solution package 18 comprise a cleaning agent. The cleaning agent may be soap, disinfectant solution, and the like. The solution package 18 may be formed from water soluble material, thereby dissolving the solution package 18. The front panel 11 includes a plurality of apertures 20 thereon. The apertures 20 are in fluid communication with the solution package 18, such that upon release of the cleaning agent from the solution package 18, the cleaning agent permeates the front panel 11 via the apertures 20. Thus, the cleaning agent may be selectively deposited on surfaces by a user.

In the illustrated embodiment, the solution package 18 is positioned between the reinforcing layer 13 and the front panel 11. In this way, a user can release the cleaning agent by pressing the base panel 12 towards the front panel 11, whereby the pressure causes the solution package 18 to rupture and release the cleaning agent on the front panel 11. In an alternative embodiment, the solution package 18 may be integrated into the reinforcing layer 13, disposed lateral the reinforcing layer 13, or the like, as to ensure that the solution can permeate through the front panel.

In one exemplary use, a cleaning pad 10 is selected and handled by a user. The user actuates a pull tab 19 that is operably connected to the solution package 18, wherein the cleaning agent is released therefrom. A user may further press the base panel 12 towards the front panel 11 so as to discharge the cleaning agent through the apertures 20 of the front panel 11. The reinforcing layer 13 with textured elements is selectively and frictionally engaged with a desired surface, such as wiping after defecation. The cleaning pad 10 is discarded into a toilet bowl, whereby the cleaning pad 10 dissolves or otherwise breaks apart upon therein. In an alternative embodiment, the textured elements 23 are disposed on the front panel 11.

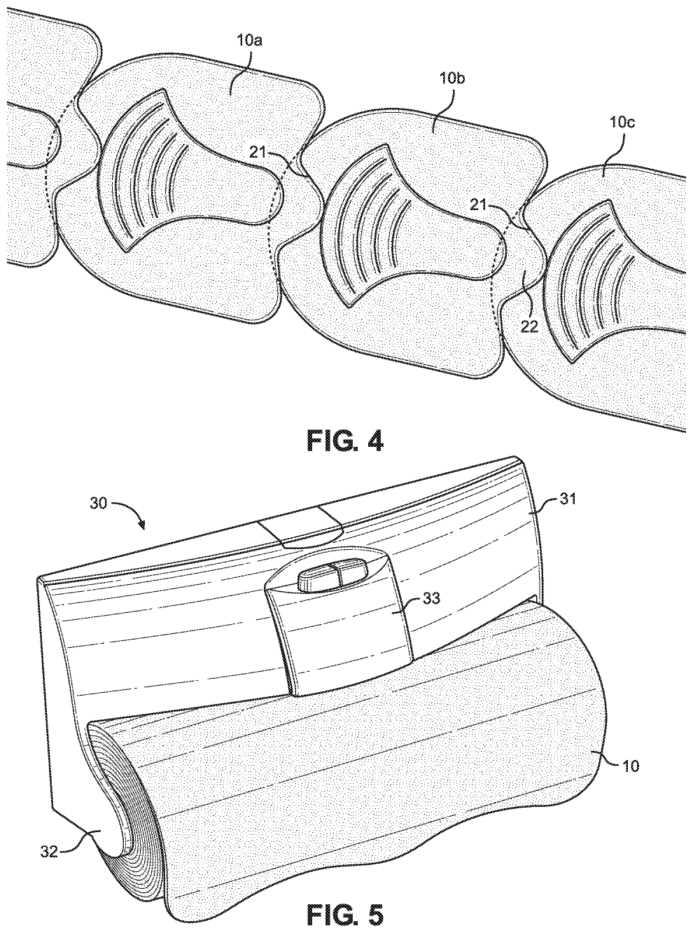

Referring to FIGS. 4 and 5, there is shown a plurality of cleaning pads joined end to end and a plurality of cleaning pads mounted to a solution dispensing device, respectively. In the shown embodiment, a plurality of cleaning pads 10a, 10b, 10c are removably affixed end to end with adjacent cleaning pads, such that plurality of cleaning pads 10a, 10b, 10c may be stored in a rolled configuration. The adjacent cleaning pads, a first cleaning pad 10a and a second cleaning pad 10b, are removably affixed at a transverse perforated edge 21. The transverse perforated edge 21 is formed between a second end of the first cleaning pad and a first end of the second cleaning pad. Further, indicia 22 is disposed on the cleaning pad 10b. Specifically, the indicia 22 is disposed on the protruding tab of the front panel, however, in alternative embodiments, the indicia 22 may be disposed anywhere on the cleaning pad 10b.

In the shown embodiment, the second end is curved between the tab and recesses of the first cleaning pad 10a and the first end of a second cleaning pad 10b. Thus, the transverse perforated edge 21 formed between adjacent cleaning pads 10a-10b and 10b-10c corresponds to the shape of the ends of the adjacent cleaning pads.

Specifically referring to FIG. 5, the plurality of cleaning pads 10 are in a rolled configuration and suspended on a roller 32 below the housing 31 of the solution dispensing device 30. A trigger is configured to release the contents of the solution chamber 33 onto the cleaning pads 10.

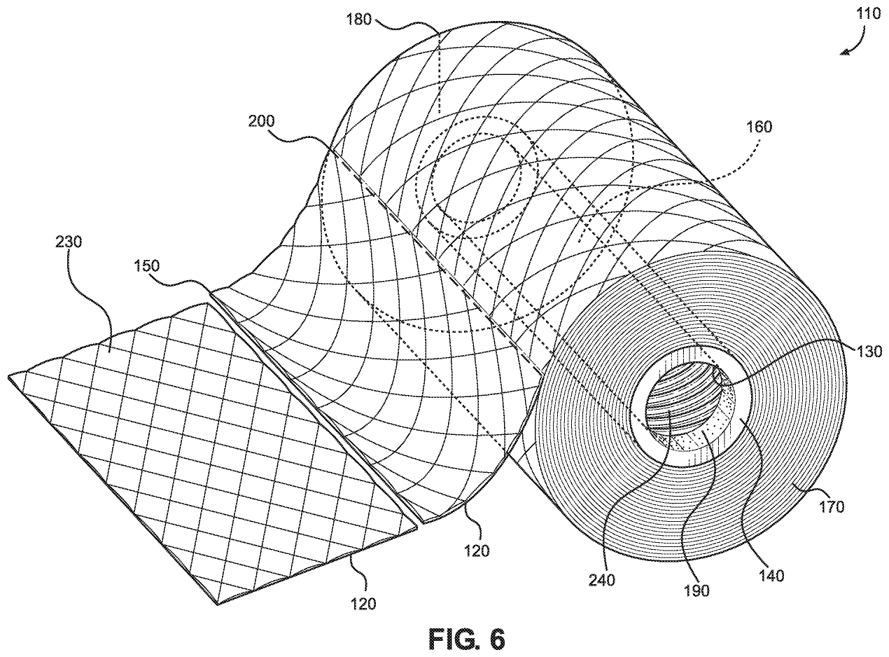

Referring now to FIG. 6, there is shown a perspective view of an embodiment of the paper roll. The paper roll comprises a plurality of sheets 120 spirally wound to form a roll 110 having a first end 130 and a second end 150, wherein the second end 150 comprises the outer terminal end of the roll 110. In the illustrated embodiment, the plurality of sheets 120 further comprise perforations 200 extending along the length of the plurality of sheets 120. The perforations 200 are disposed between adjacent sheets and are configured to allow a user to separate adjacent sheets. In some embodiments, the plurality of sheets 120 further comprise textured elements 230 thereon. The textured elements 230 are configured to increase the surface area in contact with a user, thereby aiding in cleaning the area as more dirt can be accumulated thereon. This happens because the texture area traps debris that would otherwise be wiped over. Additionally, the textured elements 230 provide a pleasant sensation and increase comfort for the user. In the illustrated embodiment, the plurality of sheets 120 comprise a single ply, however in alternate embodiments, the plurality of sheets 120 comprise a plurality of plies.

The first end 130 forms an inner section 140 of the roll 110. The inner section 140 comprises several layers of plurality of sheets 120 of the first end 130 bonded together by an adhesive 190 to provide rigidity to the inner section 140. This provides the roll 110 with structural integrity similar to that provided by a traditional cardboard tube. In some embodiments, the inner section 140 further comprises a corrugated inner surface 240. The corrugated inner surface 240 is formed as the plurality of sheets 120 are layered together and is configured to provide additional strength and rigidity to the inner section 140.

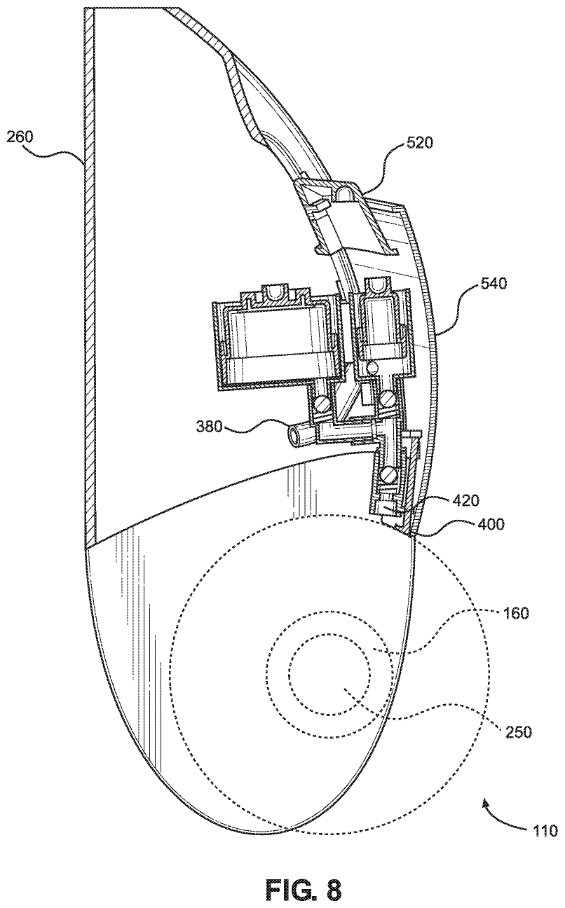

In the illustrated embodiment, the inner section 140 forms an axial passageway 160 extending between a first side 170 and a second side 180 of the roll 110. The axial passageway 160 is configured to receive a rod (shown in FIG. 8, 250) therethrough, such as a toilet paper holder. In the illustrated embodiment, the axial passageway 160 comprises a substantially circular cross-sectional shape. In this way, the axial passageway is configured to allow a user to evenly dispense the plurality of sheets 120 from the roll 110 as the roll 110 rotates about the rod smoothly. In alternate embodiments, the axial passageway 160 can comprise various other shapes, so long as the width of the axial passageway 160 is sufficient to receive a rod therethrough.

In the illustrated embodiment, the inner section 140 is bonded by an adhesive 190. The adhesive 190 is configured to penetrate through several layers of the plurality of sheets 120. These bonded layers stiffen the inner section 140 to provide structural integrity to the roll 110 such that the roll 110 does not collapse under its own weight. In some embodiments, the adhesive 190 is configured to penetrate four to six layers of the plurality of sheets 120. In another embodiment, the adhesive 190 is configured to increase the rigidity of the inner section 140 to at least twice that of the second end 150. The adhesive 190 is further configured to degrade when in contact with water. In this way, the inner section 140 loses its rigid properties, regaining the physical properties of the plurality of sheets 120. This allows the inner center 140 to be disposed of similarly to the plurality of sheets 120, such as via flushing into a toilet. In some embodiments, the adhesive 190 comprises polyvinyl alcohol.

In some embodiments, the adhesive 190 further comprises a fragrance agent configured to emit a scent when exposed to air or water. In this way, when the roll 110 is rotated about the rod, the fragrance agent is activated by the increased airflow through the axial passageway 160, causing a pleasant scent to be emitted from the inner section 140. Furthermore, when the user disposes of the inner section 140 in a toilet, the fragrance agent is activated when it contacts the water, releasing a pleasant scent. In another embodiment, the adhesive 190 further comprises a non-chemical disinfectant configured to sanitize a container having a volume of water therein, such as a toilet bowl, after a predetermined amount of time in contact with the water. In some embodiments, the amount of time required to sanitize the container is greater than that required to degrade the adhesive 190. In this way, the disinfectant provides an efficient and simple means of cleaning the container.

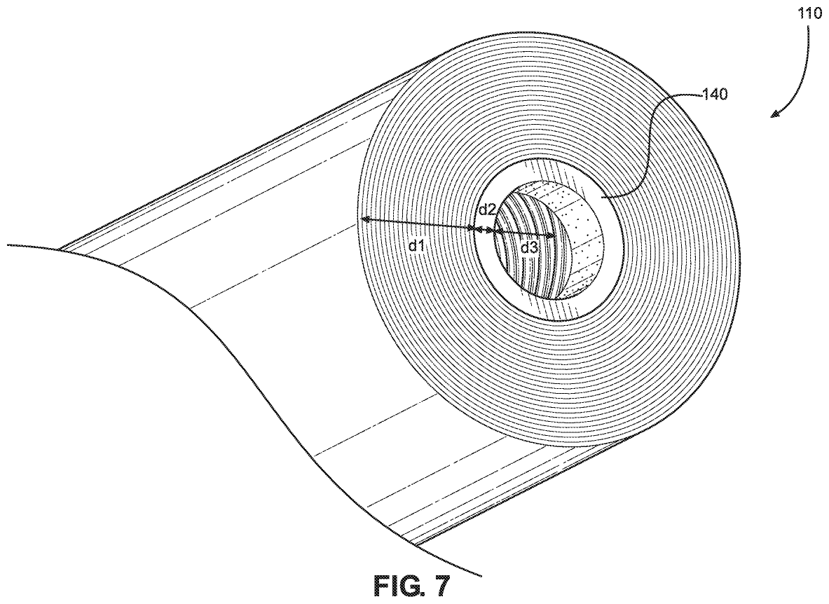

Referring now to FIG. 7, there is shown a side view of an embodiment of the paper roll. In the illustrated embodiment, the inner section 140 comprises a thickness d2. In order to support larger rolls 110, the thickness d2 increases relative to increases in a final width d1 of the roll 110. The final width d1 comprises the desired width of the plurality of sheets comprising the roll 110 at the end of manufacturing. In this way, the inner section 140 is configured to provide increased rigidity to support the added weight of larger final widths d1 of the roll 110. The internal radius d3 of the inner section 140 comprises the radius of the axial passageway. The internal radius d3 is configured to fit the rod therethrough.

To increase the thickness d2 of the inner section 140, additional layers of tissue and adhesive is applied to the plurality of sheets during the manufacturing process, such that the adhesive penetrates further layers of the plurality of sheets. As the adhesive cures, the rigidity and strength of the inner section 140 increases. In this way, the inner section 140 can support increased weight and stress without failing. This process can be repeated as desired to achieve the desired rigidity as required by the desired final width d1.

Referring to FIGS. 6 and 7, in one use, a user takes a number of the plurality of sheets 120 from the roll 110 by tearing one or more of the sheets from an adjacent sheet along the perforations 200. As the roll 110 is rotated about the rod holding the roll 110 in place, the fragrance agent is activated by the increased airflow through the axial passageway 160. The user then uses the removed sheet to clean himself and disposes of the removed sheet into a toilet bowl. Should the user reach the inner section 140 of the roll 110, the user can then dispose of the inner section 140 by placing it in the toilet bowl. The adhesive 190 then begins to degrade after contacting the water within the toilet bowl, which causes the inner section 140 to lose rigidity. After a set time, the adhesive 190 fully degrades. At this point the inner section 140 comprises the same physical properties of the plurality of sheets 120, such that it can be disposed of in a similar manner, such as by flushing in a toilet. In some embodiments, upon contact with the water within the toilet bowl, the fragrance agent within the adhesive 190 activates, emitting a scent therefrom. In another embodiment, a disinfectant within the adhesive 190 is activated when contacting the water of the toilet bowl. The disinfectant is configured to sanitize the toilet bowl after a set time.

Referring now to FIG. 8, there is shown a side view of an embodiment of the paper roll in a dispenser. In the illustrated embodiment, the roll 110 is mounted within a dispenser 260. The rod 250 is inserted through the axial passageway 160 of the roll 110. The rod 250 engages with opposing ends of the dispenser 260 in order to hold the roll 110 in place. The roll 110 is configured to rotate about the rod 250. In one use, a user removes a desired number of sheets from the roll 110. The dispenser 260 dispenses a fluid onto the plurality of sheets as they are detected by the dispenser 260 as being removed.

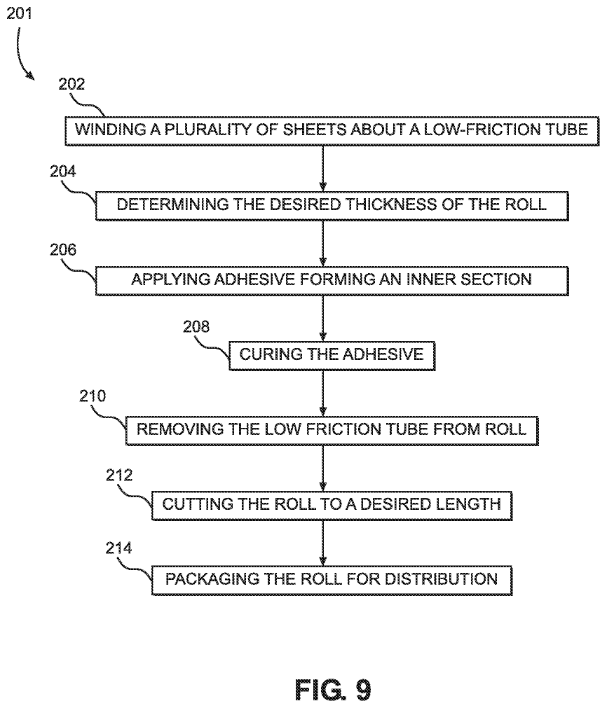

Referring now to FIG. 9, there is shown a flow diagram of an embodiment of the method of manufacturing a paper roll. The method of manufacturing a paper roll 200 comprises winding a plurality of sheets about a low friction node 202. A plurality of sheets are wound 202 about a low-friction tube to create a spirally wound roll having a first end in contact with the low-friction tube, the first end forming an inner section of the roll, and a second end disposed on the outside of the roll. In some embodiments, winding 202 the plurality of sheets further comprises pressing textured elements, such as, but not limited to, a quilted pattern, into the plurality of sheets as the roll is formed. In another embodiment, perforations are cut into the plurality of sheets across the length thereof. In this way, adjacent sheets of the plurality of sheets can be separated about the perforations.

In some embodiments, the low-friction tube comprises a tubular platen having a plurality of recesses thereon, wherein each of the plurality of recesses comprises an aperture therein. In this embodiment, air is circulated through the tubular platen such that negative pressure is generated at the apertures, thereby securing the plurality of sheets to the tubular platen for rolling. Additionally, as the plurality of sheets are layered on top of each other, the plurality of recesses form a void space between layers such that a corrugated texture is formed in the inner section of the roll. This corrugated pattern adds structural integrity to the roll.

The method of manufacturing the paper roll further comprises determining the desired thickness of the roll 204. At this time, a user determines 204 the overall desired size and thickness of the roll to be manufactured. The larger the roll, the greater the stresses placed on the inner section of the roll, and therefore, the greater the required strength and rigidity of the inner section to resist those stresses.

An adhesive is then applied to the roll to form an inner section 206. The adhesive is applied 206 during the winding 202 process, such that multiple layers of the plurality of sheets are bonded together. In some embodiments, the adhesive is configured to penetrate and bond 4-6 adjacent layers of the plurality of sheets. If the inner section requires increased strength and rigidity to counteract the weight of the roll, additional layers of adhesive can be applied 206 such that the thickness of the inner section is increased. In this way, the thickness of the inner section can be increased by an additional 4-6 layers of the plurality of sheets each time a new layer of adhesive is applied 206.

In one embodiment a reinforcement membrane will be applied to the plurality of sheets before they are rolled into the core. This adding of the reinforcement membrane will allow the core to be stronger. The reinforcement membrane will add another layer to the core. This will strengthen the core. Further, this layer will dry only after being rolled into the core shape. This will add additional structure and form to the core. In one embodiment this process will better enable the core to spring back to the original shape if the core should be smashed or bent. In one embodiment this process can reduce the amount of sheets needed to create the core.

Once the desired thickness of the inner section is achieved, the adhesive is then cured 208. In one embodiment, curing the adhesive 208 comprises allowing the inner section to dry over time. In some embodiments, the temperature of the air circulated through the tubular platen is configured to decrease the curing 208 time of the adhesive applied. In this way, the curing 208 process can be completed more efficiently.

The winding 202 stops once the desired size of roll is reached. At this point, the curing 208 process is complete and the low-friction tube is removed 210 from the roll. In some embodiments, once removed from the low-friction tube, the method 201 further comprises cutting the roll to a desired length 212. In another embodiment, the method 201 further comprises packaging the roll for distribution 214.

In another embodiment, the adhesive comprises polyvinyl alcohol mixture. In one embodiment the adhesive for forming a rigid object, comprises a polyvinyl alcohol mixture and a pliable substrate; the adhesive configured to form a rigid object; wherein the rigid object is dissolvable in a solution. The pliable substrate includes, but is not limited to fibrous material, such as paper.

In one embodiment, application of the adhesive to a pliable substrate causes the pliable substrate to form the rigid object upon drying thereof. The adhesive may further comprise an additive of graphite configured to increase conductivity of the adhesive. The adhesive is oil and solvent resistance to materials.

A method of forming a rigid object, comprising: applying an adhesive to a pliable substrate, wherein the adhesive include a polyvinyl alcohol mixture; wherein the adhesive configured to cause the pliable substrate into a rigid object upon drying; drying the adhesive such that the pliable substrate forms the rigid object.

In one embodiment, the method further comprises moistening the pliable substrate; positioning the pliable substrate within a mold to be coextensive with a molding surface of the mold.

In one embodiment, the method further comprises positioning the substrate onto a mandrel, wherein the rigid object maintains an exterior shape of the mandrel.

In one embodiment, the method further comprises positioning the pliable substrate between an inner mold and an outer mold, wherein the inner mold mates with the outer mold defining an interior adapted to receive the pliable substrate, wherein the adhesive is applied between coextensive layers of the pliable substrate; wherein the pliable substrate is pressed so as to form the rigid object having a shape of the interior.

In one embodiment, the method further comprises positioning the pliable substrate between an inner mold and an outer mold, wherein the inner mold mates with the outer mold defining an interior adapted to receive the pliable substrate, wherein the polyvinyl alcohol adhesive is applied between coextensive layers of the pliable substrate; wherein the pliable substrate is pressed so as to form the rigid object having a shape of the interior.

In one embodiment, the method further comprises blowing the pliable substrate onto a mold.

In one embodiment, the method further comprises applying the pliable substrate to an interior of a mold, the pliable substrate further includes fiber or cellulose, wherein the mold is rotated causing the pliable substrate to form the rigid object having a hollow interior volume; warming the mold to release the rigid object therefrom.

In one embodiment, the method further comprises injecting the pliable substrate to an injection mold, the pliable substrate further includes fiber or cellulose; applying pressure to the injection mold.

In one embodiment, the method further comprises extruding the pliable substrate thru a mold, the pliable substrate further includes fiber or cellulose.

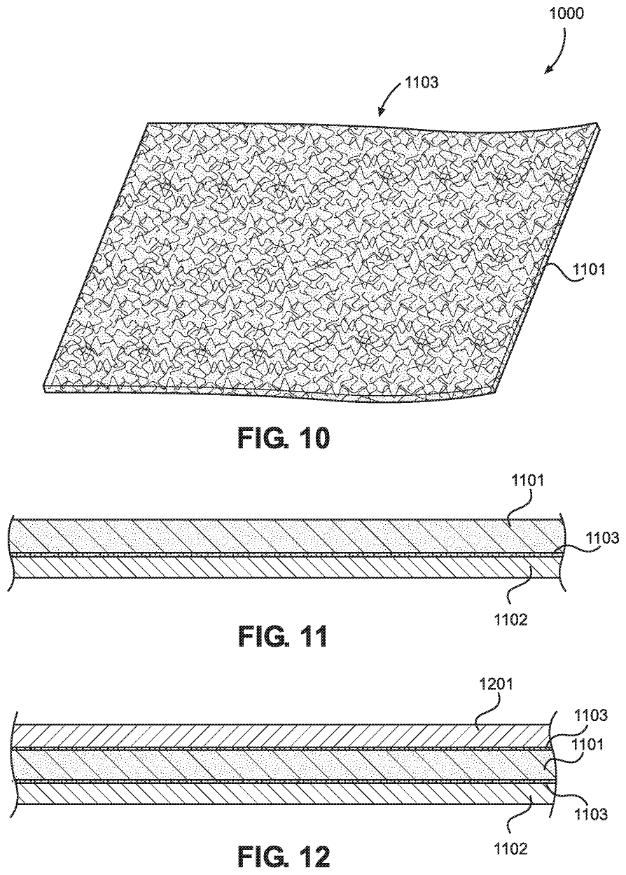

Referring now to FIG. 10 there is shown a perspective view of an embodiment of a cleaning pad using an adhesive. The cleaning pad 1000 is created from having at least a first material coated in an adhesive. The adhesive has a polyvinyl alcohol base. In one embodiment the adhesive has gum ingredient added. When the adhesive is dry it forms a membrane on the material. This membrane will make a single piece of tissue paper strong enough to prevent puncture. In one embodiment the adhesive is sprayed onto a single side of the tissue paper. In a second embodiment the adhesive is sprayed onto both sides of a piece of tissue paper.

In one embodiment the cleaning pad is made using only one layer of tissue paper 1101. In one embodiment the tissue paper is a single ply toilet paper. In another embodiment the tissue paper is a paper towel. The adhesive 1103 is applied to a single side of the tissue paper and this creates the cleaning pad. In this embodiment the cleaning pad is a single ply.

In one embodiment the cleaning pad 1000 can be textured. In this embodiment the texturing is applied by pressing a texturing tool into the tissue paper. The adhesive is applied to at least on side of a piece of tissue paper then the texturing tool is pressed into the tissue paper. Once the adhesive dries tissue paper will hold the texture.

Referring now to FIG. 11 there is shown a cross-sectional view of an embodiment of the cleaning pad having two tissue layers. The cleaning pad can be a two ply. The two-ply cleaning pad is created by adding a layer of adhesive 1103 to a side of a first material 1101. Then a second layer of material 1102 is added on top of the adhesive. The adhesive will dry holding the materials together. The adhesive will create an impenetrable membrane between the layers of material. In one embodiment the first material 1101 and the second material 1102 are the same material. In another embodiment the first material 1101 and the second material 1102 are different materials.

Referring now to FIG. 12 there is shown a cross-sectional view of an embodiment of the cleaning pad having three tissue layers. The cleaning pad can be a three ply. The three-ply cleaning pad is created by adding a layer of adhesive 1103 to a side of a first material 1101. Then a second layer of material 1102 is added on top of the adhesive. The adhesive will dry holding the materials together. A third layer is then added by adding another layer of adhesive 1103 and another layer of tissue 1201. In some embodiments the adhesive will create an impenetrable membrane between the layers of material. In one embodiment the materials are all the same material. In another embodiment the materials are different materials. In one embodiment where the materials are different materials one of the materials is a reinforced material to add additional strength to the cleaning pad.

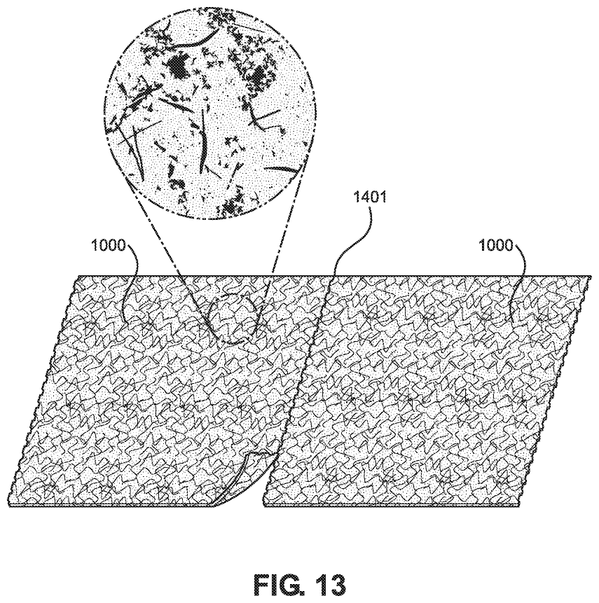

Referring now to FIG. 13 there is shown a perspective view of an embodiment of the cleaning pad connected together with perforations. In one embodiment the cleaning pads 1000 are connected together by perforations 1401. In one embodiment the perforations are placed in the cleaning pad after the adhesive is applied.

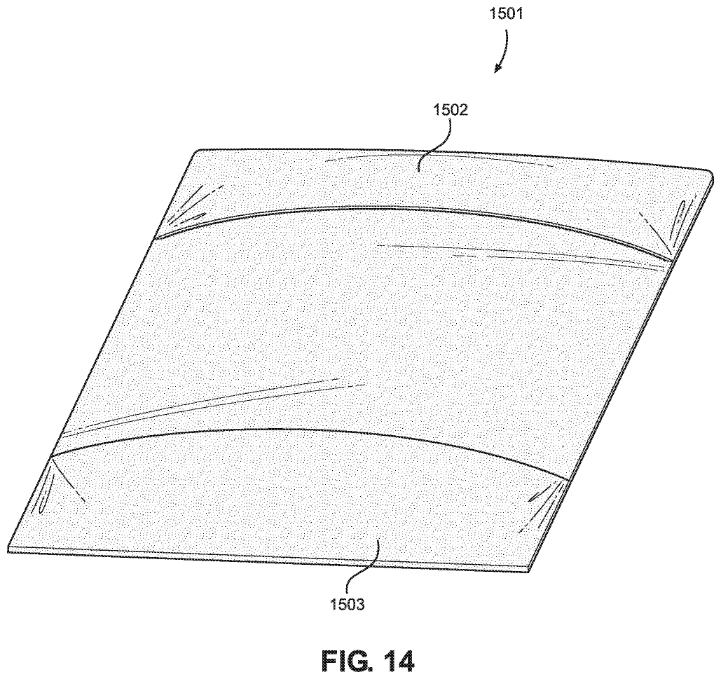

Referring now to FIG. 14 there is shown a perspective view of an embodiment of the cleaning pad with finger slots. In one embodiment the cleaning pad 1501 can be designed to have finger slots 1502, 1503. The finger slots can include a large pocket 1502. The large pocket has a first opening that opens toward a center of the cleaning pad. The large pocket may hold the index finger, middle finger, ring finger, and pinky finger or any combination thereof. There is a second large pocket 1503 located opposite the first large pocket 1502, which may be occupied by a thumb during use. This design will allow a hand to be placed in the slots and control the cleaning pad. The slots are made by applying a layer of adhesive to the material then placing another layer of the adhesive covered material to the first layer. During this process it is important to leave extra material to leave room for fingers to be placed in the slots.

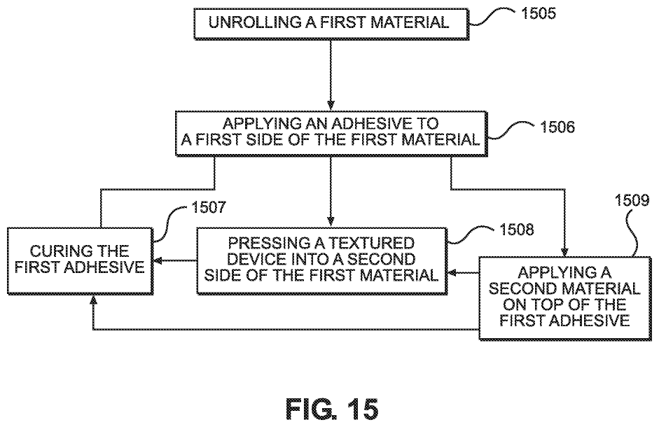

Referring now to FIG. 15 there is shown a flow chart for an embodiment of a method for making a cleaning pad. The first step is to unroll a first material from a large roll of material 1505. Next a pre-spray is applied to a first side of the first material 1506. Following the appliance of the first adhesive the process can end by curing the adhesive 1507. In one embodiment the first material is a tissue paper. In one embodiment a pre-spray that is quick drying is also added to the material. This pre-spray will prevent the material from sticking to itself as it is rolled. In another embodiment a texturing device can be pressed into the first tissue paper 1508. This will add a texture to the cleaning pad. The adhesive can then be cured 1507 and the process ended. In yet another embodiment. A second layer of material can be added to on top of the first adhesive 1509 this creates a multi-ply cleaning pad. After the second material is applied the cleaning pad can go straight to curing 1507 or have a texture pressed into the pad followed 1508 by curing 1509.

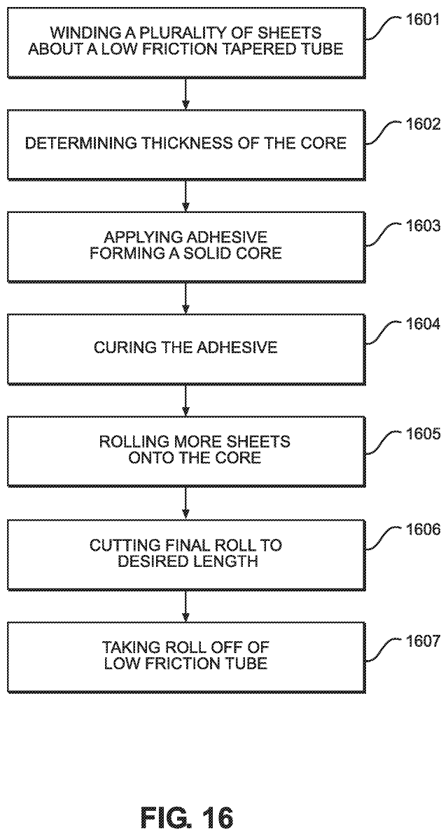

Referring now to FIG. 16 there is shown a flow chart for an embodiment of a method for making rolls of the cleaning pad. In an embodiment for making rolls of cleaning pads the method starts by making the inner tube for the roll. The inner tube is made from the same material as the cleaning pads so that the tube is disposable. The inner tube is made by first winding a plurality of sheets of material around a low friction tube 1601. While rolling the sheets on adhesive is applied to the sheets 1603. At the same time the thickness of the tube is to be determined 1602. Once the thickness is determined to be satisfactory the adhesive needs cured 1603. In one embodiment this is done by using heated air blown onto the tube.

Once the inner tube is created the cleaning pads need rolled onto the inner tube. In one embodiment this begins by rolling more material onto the roll 1605. In one embodiment while the material is being rolled onto the inner tube adhesive is applied to the material 1605. The roll will then need cut to length 1606. Lastly, the roll is taken off of the tube 1607.

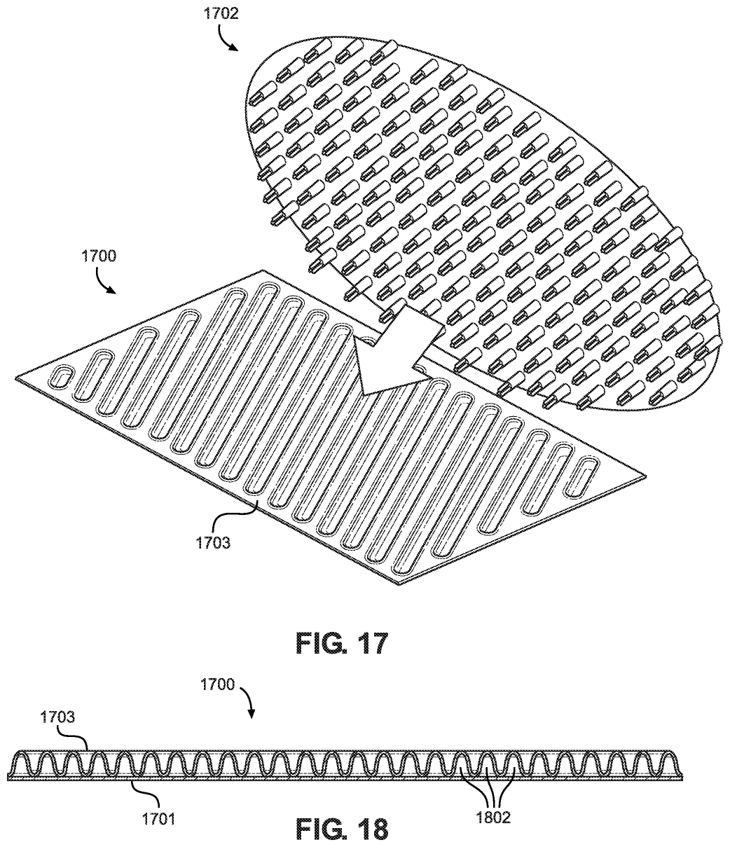

Referring now to FIG. 17, there is shown a perspective view of an embodiment of a cleaning pad having a texturing device pushing into the cleaning pad. In this embodiment a texture is placed into the cleaning pad 1700 having a reinforcement membrane. The texture is placed into the cleaning pad using a texturing device 1702. In one embodiment the texturing device 1702 is a pronged device. In another embodiment the texturing device 1702 has a plurality of grooves and channels thereon. Each of these configurations will create a texture when pressing the first material 1703 the reinforcement membrane of the cleaning pads.

The textured cleaning pad 1700 is made from at least a first layer of material 1703 and a layer of reinforcement membrane. In one embodiment the first material 1703 is made from a tissue paper. In one embodiment the reinforcement membrane contains polyvinyl alcohol. In one embodiment the first material 1703 breaks down upon contact with water. In one embodiment the reinforcement membrane breaks down upon contact with water.

When the reinforcement membrane is applied to the first material 1703 the reinforcement membrane is still wet and will need to dry and be cured. After the reinforcement membrane has been applied to a bottom side of the first material the texturing device is pressed into the top side of the first material. In one embodiment the texturing device 1702 is flat. In this embodiment the texturing device 1702 is pressed into the top side of the first material 1703. This will connect the first material to the reinforcement membrane creating a texture. In another embodiment the texturing device 1702 is a roller. In the embodiment where the texturing device is a roller the roller will have a plurality of prongs about the outside of the roller. In this embodiment the texturing device 1702 can be rolled across any number of cleaning pads creating the texture.

In one embodiment the texturing device 1702 is a heated device. In this embodiment the texturing device will be pressed into a first layer of material 1703. The heat will then melt the reinforcement membrane. This will allow the reinforcement membrane to bond to the first layer of material 1703. In one version of this embodiment the reinforcement membrane may be a sheet of polyvinyl alcohol dissolvable membrane. In another embodiment other adhesives may be used to create the reinforcement membrane. In a further embodiment, various sheets of membrane may also be used. In one embodiment a polyvinyl alcohol sheet is used. In some embodiments these sheets may be placed on a roll.

Referring now to FIG. 18, there is shown a cross-sectional view of an embodiment of a cleaning pad 1700 with texture placed therein. In the shown embodiment there is a first material 1703 and a layer of reinforcement membrane 1701. From the cross sectional view there can be seen a plurality of cavities 1802 formed by the texturing device. When the texturing device is pressed into the top of the first layer of material the texture is pressed into the first layer of material. The texture is created by attaching part of the first layer of material to the reinforcement membrane, the reinforcement membrane holds the texture in the first material.

Texturing the cleaning pad 1700 in this method also creates a further benefit. The texturing device will further create moisture cavities 1802 between the reinforcement membrane 1701 and the first material 1703. These cavities 1802 can be used to collect moisture and debris when in use. In one embodiment the cavities 1802 are a plurality of channels. In another embodiment the cavities 1802 are a plurality of bubbles. The cavities will enhance the cleaning ability of the cleaning pads by allowing the pads to trap more debris.

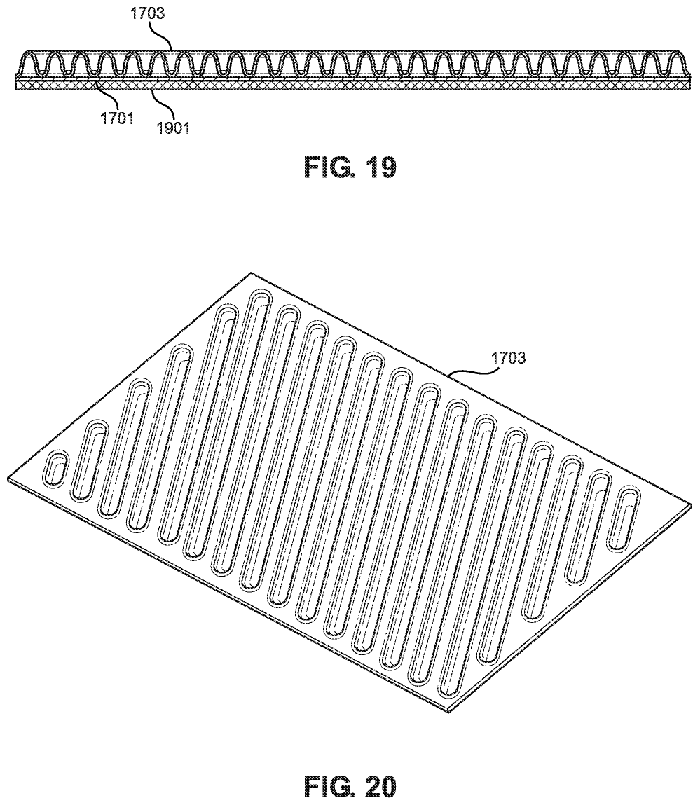

Referring now to FIG. 19, there is shown a cross-sectional view of an embodiment of a cleaning pad with a texture placed therein and a second layer of material. In the shown embodiment there is a second layer of material 1901 added to the cleaning pad. This second layer of material 1901 is attached to the reinforcement membrane 1701. This will create a cleaning pad with a second layer of material 1901 having the reinforcement membrane 1701 attached to the top side thereof. Then a first layer of material 1703 is placed thereon. The first layer of material 1703 is textured creating the textured cleaning pad. The second layer of material 1901 will help to add an extra absorption layer to the cleaning pad.

Referring now to FIG. 20, there is shown a perspective view of an embodiment of the textured cleaning pad. In this view there is shown a plurality of billows in the first layer of material 1703. The billows are in a diagonal configuration but can be placed in any number of configurations. The cleaning pad is shown as a square however, other shapes and designs are contemplated by this disclosure.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cleaning pad, comprising:
At least a first layer of material attached to a reinforcement membrane;
a texture in a top side of the first material, wherein the texture creates a plurality of pockets between the first layer of material and the reinforcement membrane.

2) The cleaning pad of claim 1, further comprising a second material located on a bottom side of the first material, wherein the reinforcement membrane is located between the first material and the second material.

3) The cleaning pad of claim 1, wherein the reinforcement membrane comprises poly vinyl alcohol.

4) The cleaning pad of claim 1, wherein the reinforcement membrane is a sheet of reinforcement membrane material.

5) The cleaning pad of claim 4, wherein the sheet of reinforcement membrane consists essentially of poly vinyl alcohol.

6) The cleaning pad of claim 2, further comprising a second layer of reinforcement membrane placed on a bottom side of the second layer of material.

7) The cleaning pad of claim 6, further comprising a third layer of material attached to the top side of the first layer of material.

8) The cleaning pad of claim 1, wherein multiple cleaning pads are connected together at an edge.

9) The cleaning pad of claim 8, wherein the cleaning pads are connected together using an easy tear edge leading into perforations.

10) A method for making a cleaning pad, comprising:
applying a reinforcement membrane to a back side of a first material;
pressing a texturing device into a front side of the first material, wherein the texturing device creates a texture on the front side of the first material;
drying the reinforcement membrane on the back side of the first material.

11) The method for making a cleaning pad of claim 10, further comprising applying a second material to the back side of the first material, wherein the reinforcement membrane is between the first material and the second material.

12) The method for making a cleaning pad of claim 11, further comprising applying a second layer of reinforcement membrane to the bottom of the second material.

13) The method for making a cleaning pad of claim 10, further comprising forming a plurality of cleaning pads into a rigid center core, wherein the core is created from a plurality cleaning pads and an adhesive.

14) The method for making a cleaning pad of claim 10, wherein the texturing device is a heated element.

15) The method for making a cleaning pad of claim 10, wherein the reinforcement membrane is a water dissolving sheet.

16) The method for making a cleaning pad of claim 10, wherein the reinforcement membrane sheet is poly vinyl alcohol.

17) The method for making a cleaning pad of claim 10, wherein the applying step includes spraying the reinforcement membrane onto the first material, wherein the reinforcement membrane comprises poly vinyl alcohol.

18) The method for making a cleaning pad of claim 10, further comprising mixing a gum based material with poly vinyl alcohol to create the reinforcement membrane.

19) The method for making a cleaning pad of claim 10, further comprising mixing plasticizers with poly vinyl alcohol to create the reinforcement membrane.
